(19) United States
(12) Patent Application Publication
(10) Pub. No.: US 2013/0039633 A1
(43) Pub. Date: Feb. 14, 2013

(54) METHOD AND SYSTEM FOR DOCUMENT AUTHENTICATION

(71) Applicant: Cina Wong, Norfolk, VA (US)

(72) Inventor: Cina Wong, Norfolk, VA (US)

(21) Appl. No.: 13/207,156

(22) Filed: Aug. 10, 2011

(51) Int. Cl. H04N 5/77; G06F 17/30

(52) U.S. Cl. 386/224; 707/792; 707/E17.044; 707/E17.008; 386/E05.069

(57) ABSTRACT

The present invention is directed to a system and method for preventing the forgery of documents. The system and method simultaneously electronically records digital data evidencing the form of the signature, a visual and audio record of the signing event and the notarization of the document, as well as the date and time of the event as well as a high quality scan of the signed document(s). The system and method further provides global positioning coordinates at the locus of the signing as well as the recording and storage equipment, such that the location, date, time, and participants in the signing event are subject to a predefined set of information related to the signing.

### BACKGROUND OF THE INVENTION

1. Field of the Invention

The present invention relates to the field of document authentication. More particularly, the present invention relates to a method and system for providing electronic signature recordation and storage coupled with video event recordation and storage. Further, the present invention provides for event and location identifiers to be electronically appended to the recorded electronic signature.

2. Background and Description of the Prior Art

Many legal and other documents require notarization to verify their authenticity. Even with signatures witnessed and notarized, however, attempts are made to forge documents. For example, forgeries are attempted with wills and other estate documents, with real estate documents, and the like. The act of notarizing a document is intended not to provide a statement as to the content of the document, but to provide authenticity to the signature so that at a later date, if there is a contest as to actually when and by whom a document was signed, the notarization provides a form of authentication as to the author of the signature, the location, and the date of the signature.

Clever forgers, however, attempt to duplicate signatures and notarizations to documents for illegal activities and other gain. Law enforcement and courts spend a significant amount of time investigating alleged forgeries, and determining whether or not a document is genuine or not. In addition, it is often the case that as a person gets older, their signature may become harder to identify and authenticate, making the need for some additional evidentiary evidence as to the authenticity of the signature more important. And, notaries public are human beings, and may be temporarily or permanently unavailable to attest to the authenticity of the document that they notarized. And, with the advent of computer and digital technology, more and more often documents that are relied upon to evidence transactions, wills, and the like are simply electronic copies of an original document.

Many solutions have been found to store and process electronic documents with electronic signatures. Further, many means have been found to attach electronic information to such a stored file, creating an electronic “notarization” of the document. However, such electronic “notarization” serves to assist in the authentication of the electronic copy of a document, but not the original document. To date, there are no solutions that provide multiple digital recordation data sets that can then be used later to unambiguously authenticate the signing of documents. Further, the notarization of documents occurs on a mobile basis—a notary public has to travel to where the client is located. This may be done for convenience or out of necessity. For example, it is often the case with wills and other estate documents that the individual signing the document is elderly and cannot travel. Or it may be that, such as with real estate closings, central locations are chosen so that groups of people can get together and complete simultaneous transactions and/or to ratify documents.

Further, many court cases are fought over the competency of an individual at the time that a document is signed. Traditionally, witnesses are used to attest to the competency of an individual signing a document, and a court is left to weigh the veracity of the witness statements without having the opportunity to review the event itself. However, witness memories can fade, witnesses may become ill or die, or a witness for various reasons may have their testimony questioned or impeached.

Although prior art provides various attempts to authenticate and record signing events, none of the prior art related to this matter create a multi-layer and redundant electronic record that includes date, time, physical location, video, and audio of a signing event, and the electronic record is combined with an electronic record of the document signing itself, including the signature, such that there is and can be no ambiguity as to who signed a particular document, and under what circumstances. It is of particular importance that the traditional signing event wherein an individual creates a signature that a traditional ink pen of some sort is utilized.

While there are some attempts to utilize a “multiprinter” pen that replaces a traditional pen, the details of a signature can be lost and the handwriting may be changed by using such a device, making authentication more difficult. In particular, utilizing pen designs that vary from traditional designs can cause changes in the handwriting and signature of an individual. For example, the pen of U.S. Pat. No. 7,483,552 to Pomerantz, dated Jan. 27, 2009 for PREVENTING SIGNATURE REPUDIATION IN PAPER DOCUMENTS USING SMART PENS teaches a pen that captures a user's fingerprint and that further has a plurality of print heads in the pen. Such a design, however, is problematic for several reasons. The physical additions to the pen, such as the fingerprint reader, will cause a user to alter their grip, thus creating different characteristics in their writing from their normal handwriting. The multiple printer heads will also create alterations in handwriting, such as in the speed and pressure an individual normally uses when writing or signing. One or more printer heads may clog, further altering the signature or handwriting, and because oil based inks may clog the small print heads, water based inks will have to be used, and such inks can smear or run as well as having shorter long term stability than oil based inks. Finally, the use of fingerprints requires a living and willing individual to provide a fingerprint for comparison. In the event that the person refuses or is deceased, any potential advantage gained through using such a pen is lost.

What is needed, therefore, is a means for providing unambiguous authentication of the ratification of documents, where such means is portable and creates permanent records in support of notarization.

### SUMMARY OF THE INVENTION

The present invention is a method and means for providing an electronic record of the signing of a document by an individual.

In one embodiment of the present invention, a person's signature is recorded and stored digitally as the signature is made. The signature is made on an original document using ink, while a computer interface device digitally records the signature. The event is visually recorded, and the visual recording is combined with the electronic record of the signature, with the digital information combining the digital signature and the video stored in an electronic storage device. A further level of security and authentication may be provided by simultaneously recording the audio of the signing event. The video recording device is referred to herein as a “video camera.” The term “video camera” should not be understood to be limiting, and may include any means of recording visual images whether stand-alone or incorporated into some other device, and whether the visual images are recorded in analog, digital, or some other format. For example, three dimensional optical storage devices may be utilized and still be within the scope of this invention.

Some video cameras include audio recording functionality and some do not. If the video camera does include audio recording capability, the video camera is utilized to capture the audio recording. If the video camera does not include audio recording functionality, an external or auxiliary audio recording means may be used.

In another embodiment of the present invention, a smart phone or other portable device is utilized wherein the smart phone has video and audio recording capabilities, and the smart phone is utilized in place of a stand-alone video camera and computer. In this embodiment, images and audio of the signing event are captured by the smart phone, and the captured data is combined with geolocation information obtained through the smart phone as well as the time and date of the event. The user may then use the smart phone to transmit the information to a computer and/or storage device. The information may also be sent to other recipients, and may be viewed real-time through a mobile network.

In another embodiment of the present invention, the present invention provides a system and means for determining and recording the physical location of the signature being created at the time that the document is signed, as well as the physical location of the recording equipment and storage equipment to provide uniform date, time, and position data that is electronically appended to the video recording and the digital recording of the signature itself. The compiled data record of the signing event is then stored on electronic media.

In another embodiment of the present invention, the stored data is uploaded to a user-accessible website. The uploaded data is preferentially the video recording with associated geotagging, time, date and audio; the data from the computer interface device, including the electronic record of the signature, date, time and audio of the event; and a high-quality scan of the signed document(s).

In another embodiment of the present invention, the audio related to the signing event is captured as well as the video related to the signing event.

In another embodiment of the present invention, a document to be signed is scanned and a digital image recorded of the document both prior to and after the signing event, thus providing a full record of the signing event.

In another embodiment of the present invention, the compiled data record for the signature event is copied onto permanent physical memory storage, such as onto Compact Disc (CD) or Digital Versatile Disc (DVD). The compiled data record may further be stored electronically via transmission means on one or more computer storage systems, or on removable storage devices such as hard drive and/or SD card and the like.

The present invention provides a comprehensive data set specific to and unquestionably identifying a signing event. The present invention provides an electronic record of a signing event that includes the signature, video of the signature being created, date, time, and location information coordinated and created simultaneously to create multiple layers of authenticity for the signature being made.

### DESCRIPTION OF THE DRAWINGS

FIG. 1 is a flow diagram of the method for document authentication in accordance with the present invention.

FIG. 2 is a block diagram illustrating a system in accordance with the present invention.

FIG. 3 is a flow diagram of a method for document authentication in accordance with the present invention.

FIG. 4 is a block diagram illustrating a system in accordance with the present invention.

### DESCRIPTION OF A PREFERRED EMBODIMENT

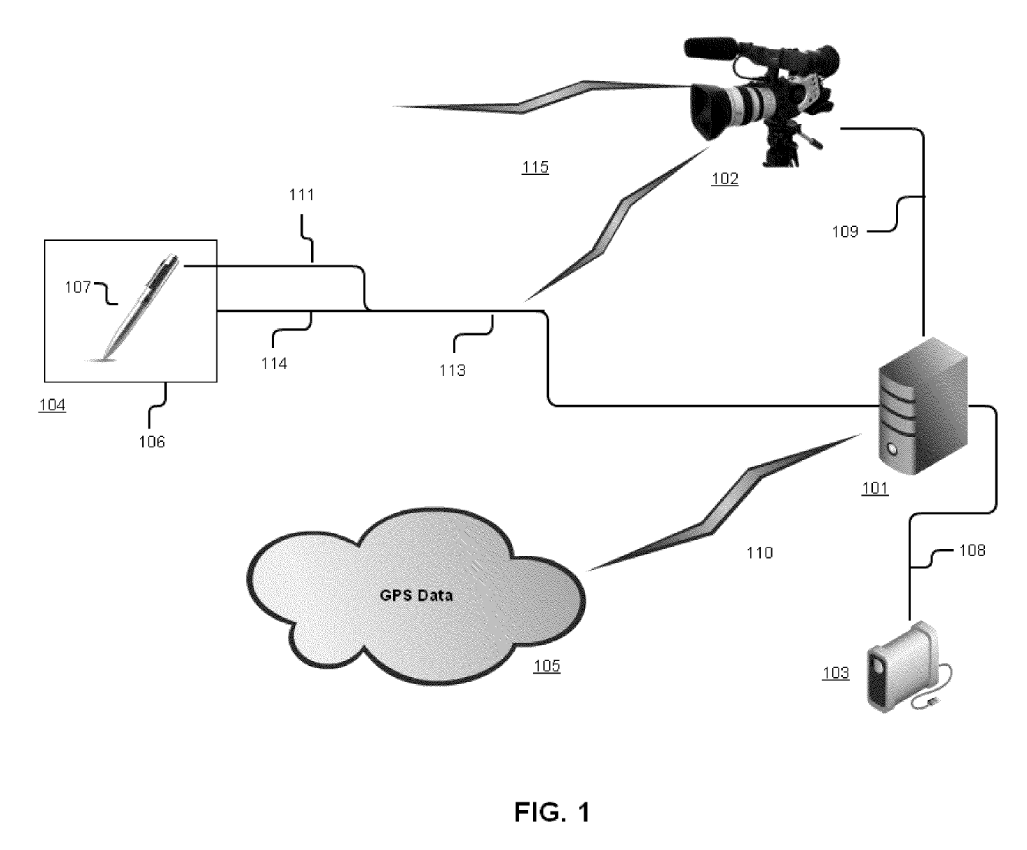

Referring now to FIG. 1, a diagram of an embodiment of the present system is shown. As shown, this embodiment of the present invention comprises a computer 101, a video camera 102, electronic storage 103, data input devices 104 and GPS data source 105. The video camera is communicatively connected 109 with the computer 101. The GPS data source 105 and the electronic storage 103 are also communicatively connected 108, 110, to the computer 101. The data input devices 104 may include a digital recording interface 106, as well as a pen 107. The data input devices 104 are communicatively connected 113 to the computer 101. In collecting the digital data generated by the signing of a document, the digital recording interface 106 may be used by itself, a pen 107 that records digital information may be used, or a digital recording interface 106 and a pen 107 that records digital information may be used in conjunction with each other. A pen 107 that records digital information, if used, is communicatively connected 111 to the computer 101, as is the digital recording interface 106. While in use, the digital recording interface 106 sends a digital representation of any signature made on a document that is placed on the surface of the digital recording interface to the computer 101. It will be understood that the digital recording interface 106 may be communicatively connected 113 by wired, wireless, or other means and still fall within the scope of this invention.

In one embodiment, a pen 107 is utilized that records digital information, and the pen 107 sends a digital representation of a signature to the computer 101. In such an embodiment, the pen may operate alone to capture a digital representation of the signing event, but it will be understood that a pen may be used in conjunction with a tablet where either or both the tablet and pen capture the digital representation of the signing event and either or both the tablet and the pen are communicatively connected to the computer that is being utilized to capture the event.

In another embodiment, the pen itself may incorporate a camera that records the signing event, although it is preferable that such a configuration be used in conjunction with the video camera 102 is positioned such that the field of view 115 encompasses the entirety of the signing event, including the face and hands of the signing individual. Preferentially, the video camera 102 is turned on and the image field and focus confirmed prior to beginning the signing event. During the signing event, the data from the data input devices 104, the video camera 102, and the GPS 105 and date/time data are combined by the computer into a combined data file, and the data file is stored using electronic storage 103.

It will be understood that the combined data file may also be copied onto recording media such as CD or DVD, and may also be transmitted electronically to other computers, storage devices, servers, or cloud storage configurations. Multiple copies of the combined data file may be desired such that the possibility of erasure/alteration is minimized. The combined data file may also be encrypted for security purposes.

It will also be understood that the video camera 102 may record the data digitally or in analog form. The video camera may further have internal analog and/or digital storage that is utilized to create a simultaneous recording to the video information transmitted to the computer. In a preferred embodiment, the video camera also incorporates audio recording means, such that the voices and the discussion related to the signing event are recorded with the video recording. The video camera as shown in this FIG. 1 is a stand-alone video recording device. However, it will be understood that modern smart phones and other portable electronic devices, such as tablet computers, incorporate video cameras and are preferentially used for the video information captured in the context of the present invention. It will also be understood that “video camera” will encompass digital cameras that have the ability to record video and audio in addition to their primary function of recording still images.

It will also be understood that the digital recording device may consist of any means for capturing an electronic data set of handwriting as the handwriting is being performed. Various techologies exist for capturing the movement of a person or object, and as electronic devices and recording means improve so too improve the ability to deviate from traditional means of signing documents. While the application of pen on paper still remains a preferable means of recording a signature, the present invention may be utilized to assist in the recordation and authentication of an event requiring manual human input to create a signature or other handwriting, regardless of how such input is recorded. For example, joysticks, rollerballs, gloves, remote motion-sensing handheld devices and the like are used to transmit human input to an electronic device.

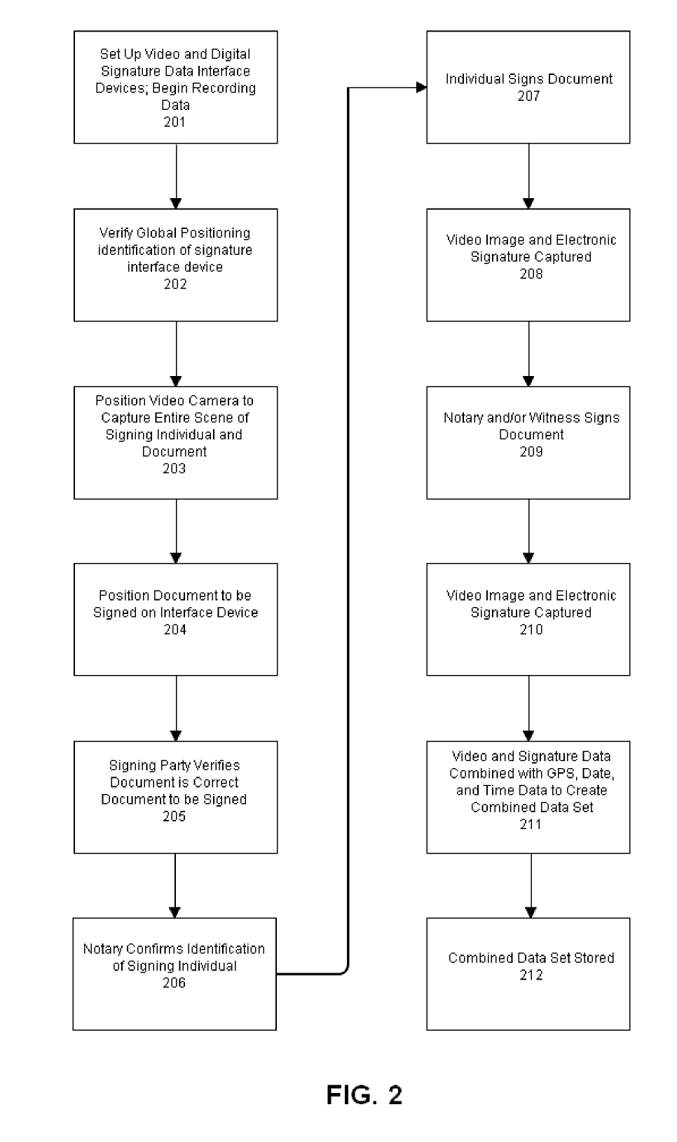

Referring now to FIG. 2, a flow diagram of an embodiment of the present invention is shown. Prior to a document being signed in accordance with this invention, the video and digital signature data interface devices are set up 201 and connected with the computer (see FIG.1). The operation of the video and digital signature data interface devices is confirmed, and the user verifies the GPS position of the signature interface device 202. The user positions and/or adjusts the video camera as necessary to ensure that the entirety of the signing event is being captured, including a full visual of the individual signing the document 203. The document to be signed is placed on the interface device 204, and the individual that is to sign the document verifies that the document so placed is the document intended to be signed 205. If the document is to be notarized by a notary, the notary confirms the identification of the individual signing the document 206. The interaction between the notary and the individual signing the document is preferentially captured by the video recording device; the entirety of the signing process is recorded in this manner in a single, unbroken video recording so that there is no opportunity to alter the video recording.

Once the individual's identity is confirmed, the individual signs the document 207. During the signing process, the video imagery and the electronic signature are captured and transmitted to the computer 208. The notary and/or witnesses then sign the document 209, and the video imagery and the electronic signature(s) are captured and transmitted to the computer 210. The video and signature data are then combined 211 with the GPS, date and time data to create a single combined data set. The combined data set is then stored 212 in a desired manner, be it on an electronic storage device that is internal or external to the computer, to another computer, device or group, by copying the combined data set onto permanent storage media, or a combination thereof.

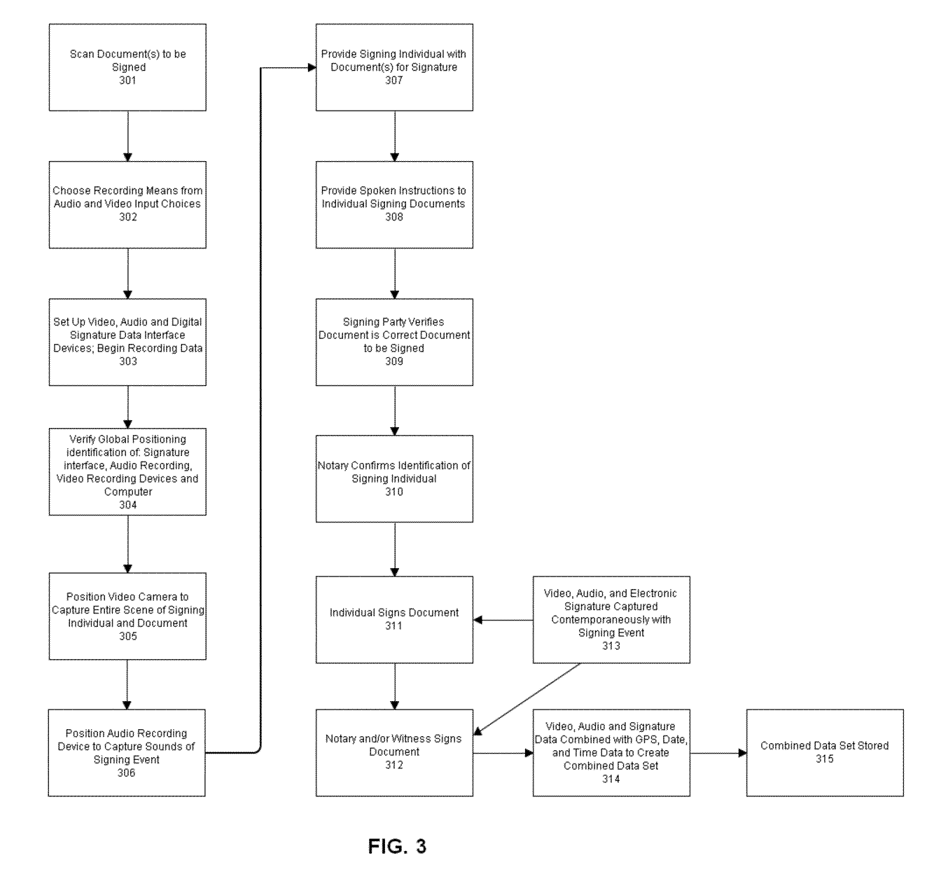

Referring now to FIG. 3, a flow chart diagram of an embodiment of the present invention is shown. Prior to a document being signed in accordance with this invention, the document to be signed is scanned 301, producing a digital record of the document without a signature. The recording means are chosen 302, and the video, audio and digital signature data interface devices are set up and recording is begun 303. The operation of the video and digital signature data interface devices is confirmed, and the user verifies the GPS position of the signature interface device, audio and video recording devices and the computer 304. The user positions and/or adjusts the video camera as necessary to ensure that the entirety of the signing event is being captured, including a full visual of the individual signing the document 305. An audio recording device is positioned 306 in order to capture the sounds of the signing event. The signing individual is given the document(s) to be signed 307. The signing individual is then instructed 308 on the signing and procedure, and because the sounds are being recorded, the audio of the instructions and other interactions between the signing individual and the notary or other user is captured electronically to be appended to the electronic record of the signing event. The signing party verifies that the document so placed is the document intended to be signed 309, and the notary public confirms 310 the identity of the signing individual by both review of proper identification and by voice. The identification (i.e., driver's license or the like) is also recorded visually. The interaction between the notary and the individual signing the document is captured by the video and audio recording devices; the entirety of the signing process is recorded in this manner in a single, unbroken video and audio recording so that there is no opportunity to alter the video recording.

Once the individual's identity is confirmed, the individual signs 311 the document, as does the notary and/or witness 312. During the signing process, the video, audio, and electronic signature are captured 313 contemporaneously with the signing event. The video, audio, signature, GPS, date and time data are combined 314 to create a combined data set, which is then stored 315. A scanned (digital) copy of the signed document may be combined with the data set as well.

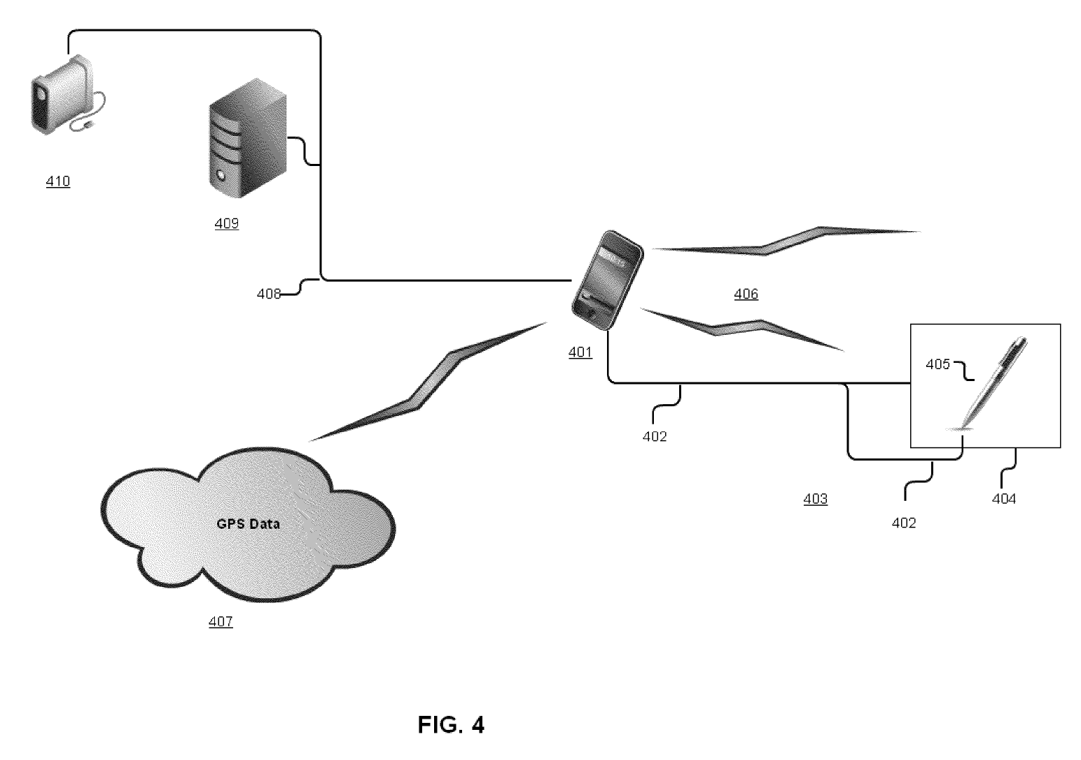

Referring now to FIG. 4, a diagram of an embodiment of the present system is shown. As shown, this embodiment of the present invention comprises a portable smart phone device 401, a electronic storage 410, data input devices 404 and GPS data source 407. The portable smart phone device 401 is electronically connected 402 to the data input devices 404. While the figure shows a pen 405 and a tablet 404, it will be understood that the pen 405, if chosen from the group of pens that provide digital signals while in use, the pen 405 may be communicatively connected 402 to the smart phone device 401, and there is no need to also capture signature information using a tablet 404 or other digital device. The smart phone device 401 will comprise storage, audio and video recording means, and the audio and video recording means are utilized to capture 406 video and audio of the signing event. The location of the smart phone device 401 and the signing event are obtained through GPS data means 407, preferentially utilizing wireless or other network means built into the smart phone device 401. Once the data associated with the signing event is captured on the smart phone device 401, the information may be communicated 408 to a computer 409 and/or a digital storage device 410.

It will be understood that, in one embodiment of the present invention, a pen or a tablet device may be utilized to capture representations of a signature as the document is signed. It will also be understood that a pen and tablet device in combination may be used where both the pen and the interface surface simultaneously capture digital data and transmit that data to the computer, where the data from both the pen and the interface surface are combined into the data set of the event that includes the video data, the date and time, and the GPS location data. Using both a pen and interface surface creates additional redundancy in the system and thereby making it more difficult to alter the data or attempt to refute the recording of the signing event. Additional authentication means may be added without deviating from the scope of the invention. For example, the document to be signed may further incorporate a unique QR code that is scanned at the time of the signing event, and may be compared in the future to further assist in determining the authenticity of a document.

What is claimed is:

1. a method for authenticating signatures, the method comprising:
providing a means for electronically recording an individual signing a document, the means electronically connected to a computing device;
providing a means for recording visual images of the individual signing the document, the means. electronically connected to a computing device;
at least one storage means connected electronically to the said computing device;
providing a means for generating electronic date and time information simultaneously with the recording of the individual signing the document;
providing a means for determining the physical location of the signing event;
providing a means for electronically storing the recorded visual images;
providing a means for storing the electronic recording of the signature made by the individual signing the document; and
providing a means for combining the electronic date and time information, the physical location information, and the stored visual images with the stored electronic recording of the signature.

2. The method of claim one, further comprising a means for capturing electronic signature information from the pen used to create a signature, and wherein the electronic signature information captured from the pen is transmitted to a computing device.

3. The method of claim 1, wherein the means for capturing electronic signature information is a flat interface device upon which a document is signed, and which means for capturing electronic signature information translates the pressure of the signature as its being made to electronic format for transmission and storage.

4. The method of claim 3, further comprising the step of capturing electronic information from the pen used to create a signature.

5. The method of claim 1, further comprising the step of providing means for recording the audio of a document signing event.

6. A system for authenticating signatures, the system comprising:
an electronic interface device that captures electronic signature data representing a signature on a document;
a video camera for capturing images of an individual signing a document;
a data source providing date, time, and physical location information to a computer;
the computer comprising means for combining electronic signature data, video image data, date, time, and physical location data into a single combined data set; and
a storage means for electronically storing the combined data set.

7. The system of claim 5, wherein the system further comprises means for capturing audio related to a signing event.

8. The system of claim 6 wherein the electronic interface device that captures signature data is a pen that is utilized to sign a paper document.

9. The system of claim 6 wherein the electronic interface device that captures signature data is an electronic device that translates the pressure on its surface during a signing event into a digital record of the signature written on paper that is placed on the surface of the electronic device.
